(19) United States
(12) Patent Application Publication
(10) Pub. No.: US 2003/0237081 A1
(43) Pub. Date: Dec. 25, 2003

(54) Updating an application using database replication

(76) Inventor: Keith M. Taylor, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/177,352

(22) Filed: Jun. 21, 2002

(51) Int. Cl. G06F 9/44

(52) U.S. Cl. 717/168

(57) ABSTRACT

Various systems and methods are provided to maintain and update an application using database replication. In one embodiment, a method is provided that comprises providing a number of applications stored in a first application database in an update server, wherein each of the applications comprises a number of application components. The method further comprises performing a database replication operation with at least one application server to replicate the applications stored in the first application database in a second application database in the application server, thereby installing the applications on the application server.

### BACKGROUND

Many enterprises now provide content and applications to the public in the form of web applications, for example, through various networks such as the Internet. In a typical case, a web application may be stored on a computer system, server, personal appliance, or other device that is accessed at a predefined uniform resource locator (URL). Such web applications may be purchased and serviced by a third party vendor. Thus, in some cases, a third party vendor may service a number of web applications for a number of customers.

From time to time, a web application serviced by a third party vendor may need to be updated. Specifically, the same basic software may be employed by the vendor's multiple clients. When updates to such applications occur, the vendor is faced with the problem of taking the necessary steps to install the updated version of the application on all of the applicable devices of respective customers.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of an application update network according to an embodiment of the present invention;

FIG. 2 is a block diagram of an exemplary application update network of FIG. 1 according to an embodiment of the present invention; and

FIG. 3 is an exemplary flow chart of a request converter employed in the application update network of FIG. 1 according to an embodiment of the present invention.

### DETAILED DESCRIPTION

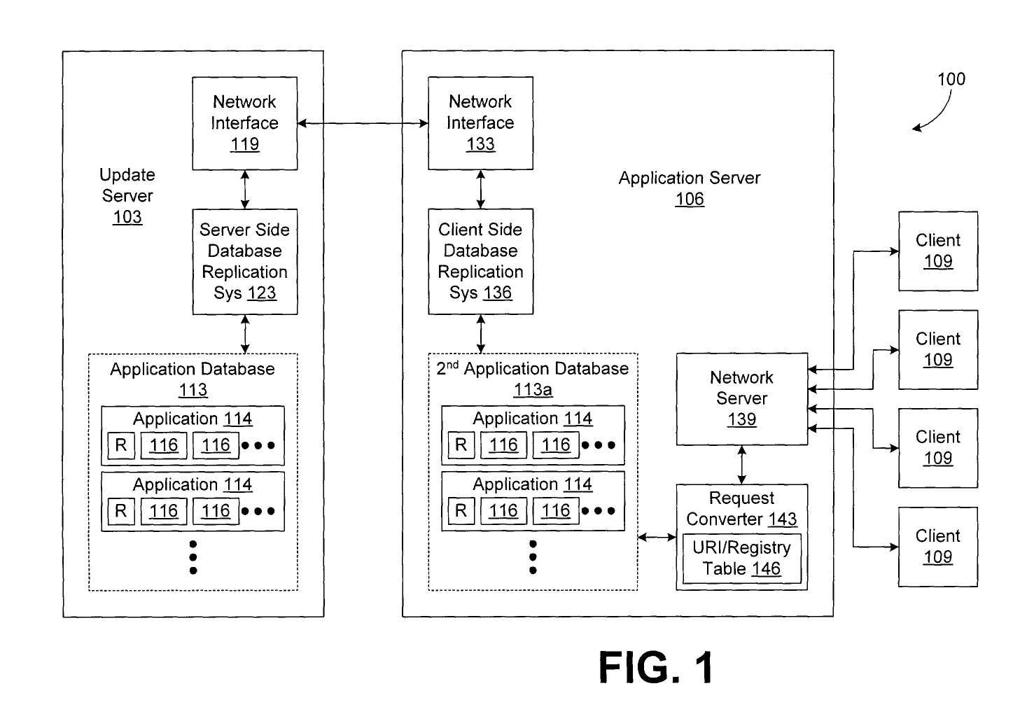

With respect of FIG. 1, shown is a functional block diagram of an application update network according to an embodiment of the present invention. The application update network 100 includes an update server 103 and an application server 106. The update server 103 and the application server 106 are in data communication with each other by virtue of a network or other media as will be discussed. The application update network 100 also includes one or more client devices 109 that are in data communication with the application server 106 by virtue of the network as will be described.

The update server 103 includes a first application database 113 in which is stored a number of applications 114. Each of the applications 114 includes one or more application components 116. The applications 114 are distributed by the update server 103 to one or more application servers 106. Associated with each application 114 is a registry R. The registry R lists the application components 116 that are associated with the application 114 with which the registry R itself is associated.

The update server 103 also includes a network interface 119, and a server side database replication system 123. The network interface 119 provides for communication with the application server 106 across an appropriate network according to a corresponding network protocol. The server side database replication system 123 is executed in the update server 103 to cause the first application database 113 to be replicated onto the application server 106 as will be described.

The application server 106 includes a network interface 133, a client side database replication system 136, a network server 139, a second application database 113a, and a request converter 143. The request converter 143 includes an Uniform Resource Indicator (URI)/Registry Table 146 that associates select ones of the registries R in the second application database 113a with respective URI's as will be discussed. The network interface 133 provides for the data communication between the update server 103 and the application server 106 according to the corresponding network protocol as was described with the network interface 119 above. The client side database replication system 136 operates in conjunction with the server side database replication system 123 to provide for the replication of the first application database 113 in the application server 106 as the second application database 113a.

The network server 139 handles various requests from the clients 109 for dynamic services or other offerings provided by the applications 114 stored in the second application database 113a. In other words, assuming that the clients 109 wish to access a dynamic service, etc., provided by the application server 106 through the network server 139, then the appropriate application 114 is accessed based upon a respective request to the network server 139.

To do this, the request received by the network server 139 is provided to the request converter 143. The request may be, for example, a Uniform Resource Locator (URI) as is employed on the World Wide Web or other type of request. The request converter 143 then determines which application 114 is associated with the URI of the request. This is done by first consulting the URI/Registry table 146 to determine which Registry R is associated with the URI of the request. Once the appropriate Registry R is known, then the request converter 143 generates a query to the second application database 114 for Registry R itself. The request converter 143 then determines the application components 114 stored in the second application database 113a that are needed to implement the desired application 114 from the Registry R.

Thereafter, the request converter 143 then generates a database query to be applied to the application database 113a for each of the application components 116 needed to implement the desired application 114. The database query is performed instead of accessing the application components 116 directly using a file system, etc., due to the fact that the application components 116 are stored in the application database 113a. Once the appropriate application components 116 have been accessed from the application database 113a, the respective application 114 is executed in the application server 106 and the appropriate response to the request from the client 109 is generated thereby.

Due to the fact that the application components 116 are stored in the respective application databases 113 and 113a, the maintenance and updating of the applications 114 stored in the application database 113a can be performed using database replication technology. Thus, the applications 114 stored in the application database 113 may be maintained by a service provider and supplied to customers who maintain a copy of the application in their application database 113a in the application server 106. In this respect, there may be multiple application servers 106 with the same second application database 113a stored thereon. To provide updated applications 114, the service provider need only update the applications 114 in the application database 113 and the server side and client side database replication systems 123 and 136 will ensure that the updated applications 114 reach the respective application servers 106. For each application server 106, the URI/Registry table 146 ensures that a respective application server 106 only provides access for the clients 109 to predetermined ones of the applications 114 in the second application database 113a. Specifically, by referencing the Registries R in the URI/Registry table 146, only applications 114 associated with the referenced registries R can be accessed. Thus, there may be various applications 114 as well as various versions of applications 114 that cannot be accessed on a given application server 106. Alternatively, various features of respective applications 114 may be inaccessible as differing Registries R may provide for differing versions of the same application 114, etc.

Accordingly, the server and client side database replication systems 123 and 136 provide for the replication of the first application database 113 in the application server 106 as the second application database 113a. Specifically, the replication operation reproduces the application components 116 stored in the first application database 113 in the second application database 113a. The performance of the replication operation may take place upon a request generated by a respective application server 106. For example, an application server 106 may request the performance of the replication operation at predetermined times.

Alternatively, the replication may take place when a change in the first application database 113 is detected by the server side database replication system 123. In such case, a table that identifies all of the application servers 106 may be maintained in the update server 103 so that the server side database replication system 123 can determine those application servers 106 with which the replication operation is to take place when appropriate. Such a change might be, for example, the addition of a new application component 116 to the first application database 113 or the deletion of one of the existing application components 116 from the first application database 113. The change may also be an alteration or replacement of one of the application components 116 in the first application database 113 or other changes to the first application database 113. When an appropriate change is detected in the first application database 113, the server side database replication system 123 may then automatically determine those application servers 106 with which the replication operation is to be performed based upon the above-mentioned table.

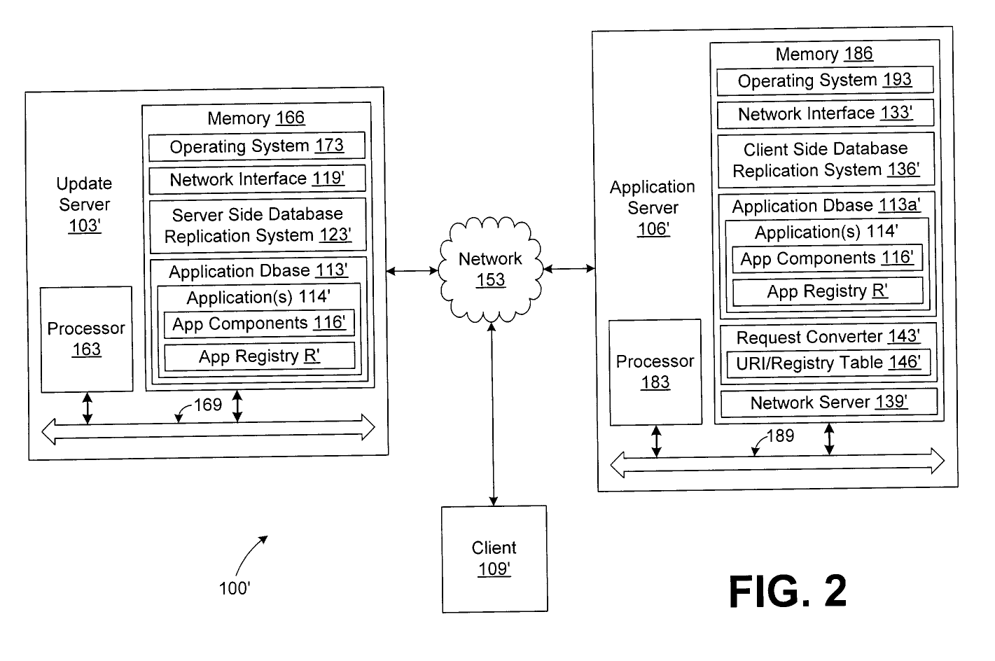

Turning then to FIG. 2, shown is one exemplary embodiment of the application update network 100 (FIG. 1) denoted herein as application update network 100′. As shown in FIG. 2, the update server 103′ and the application server 106′ comprise general purpose computer systems or other devices with like capability that have processor circuits to facilitate the execution of the various system components described herein. The update server 103′ and the application server 106′ are both coupled to a network 153. In addition, one or more clients 109′ are also coupled to the network 153. The network 153 includes, for example, the Internet, intranets, wide area networks (WANs), local area networks, wireless networks, or other suitable networks, etc., or any combination of two or more such networks.

The update server 103′ includes a processor circuit having a processor 163 and a memory 166, both of which are coupled to a local interface 169. The local interface 169 may be, for example, a data bus with an accompanying control/address bus as can be appreciated by those with ordinary skill in the art. The update server 103′ also includes a number of software components that are stored on the memory 166 and are executable by the processor 163. These components include an operating system 173, the network interface 119′, the server side database replication system 123′, a first application database 113′ that includes a number of application components 116′ that constitute an application, and the registry 126′.

Similarly, the application server 106′ includes a processor circuit having a processor 183 and a memory 186, both of which are coupled to a local interface 189. The local interface 189 may be, for example, a data bus with an accompanying control/address bus as can be appreciated by those with ordinary skill in the art. The application server 106′ also includes a number of software components that are stored in the memory 186 and are executable by the processor 183. Such software components include an operating system 193, the network interface 133′, the client side database replication system 136′, the application database 113a′ with the number of application components 116′, the network server 139′ and the request converter 143′.

The memories 166 and 186 may include either or both volatile and nonvolatile memory and data storage components. Volatile components are those that do not retain data values upon loss of power. Nonvolatile components are those that retain data upon a loss of power. Thus, the memories 166 and 186 each may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 163 and 183 may represent multiple processors and each of the memories 166 and 186 may represent multiple memories that operate in parallel processing circuits, respectively. In such a case, each of the local interfaces 169 and 189 may be an appropriate network that facilitates communication between any two of the multiple processors, between any processor and any of the memories, or between any two of the memories, etc. The processors 163 and 183 may be electrical, molecular, or optical in nature or may employ other technologies.

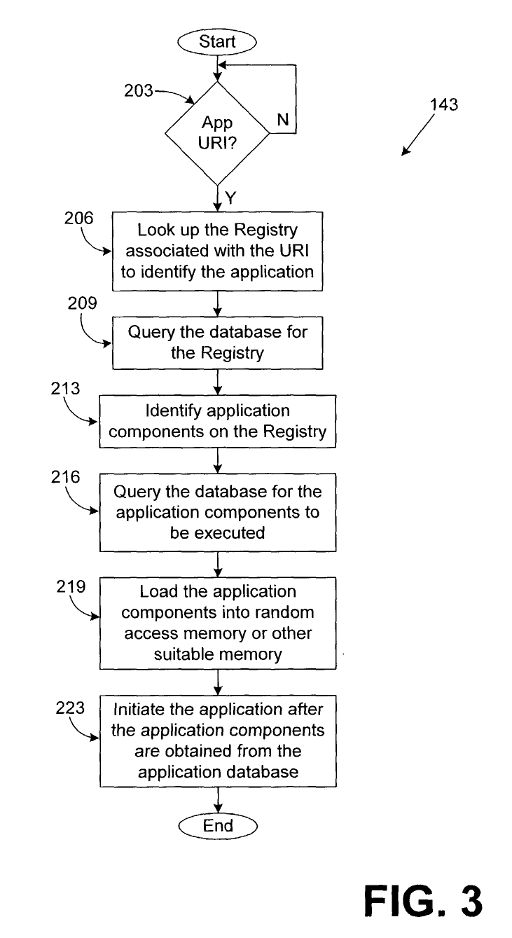

With reference to FIG. 3, shown is a flow chart that provides one example of the request converter 143 according to an embodiment of the present invention. Alternatively, the flow chart of FIG. 3 may be viewed as depicting steps of a method implemented in the application server 106 (FIG. 1) to provide access to various ones of the applications 114 (FIG. 1) by one or more of the clients 109 (FIG. 1).

Beginning with box 203, if a URI is received from the network server 139 having been received from a client 109, then the request converter 143 proceeds to box 206 in which a Registry R (FIG. 1) that is associated with the URI is looked up in the URI/registry table 146 (FIG. 1). Thereafter, in box 209, the request converter 143 generates and applies a query to the second application database 113a (FIG. 1) for the respective registry R identified in box 206. Then, in box 213, the application components 116 listed in the retrieved registry R are identified. Next, in box 216, the request converter 143 generates and applies one or more queries to the second application database 113a for the respective application components 116 associated with the desired application 114 to be executed. In box 219, the application components 114 are loaded into a random access memory portion of the memory 186. Finally, in box 223 the application 114 is executed after the application components 114 corresponding thereto are obtained and loaded into random access memory or other appropriate memory for execution as can be appreciated by those with ordinary skill in the art. In this manner, the service provided by the respective application 114 can thus be provided to the requesting client 109.

Although the server and client side database replication systems 123/136, the network interfaces 119/133, the request converter 143, and the network server 139 are described as being embodied in software or code executed by general purpose hardware in FIG. 2, in another embodiment, each may be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

In addition, the flow chart of FIG. 3 shows the architecture, functionality, and operation of an implementation of the request converter 143. If embodied in software, each block shown may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the server and client side database replication systems 123/136, the network interfaces 119/133, the request converter 143, and the network server 139 comprise software or code, each can be embodied in any computer-readable medium for use by or in connection with an instruction execution system such as, for example, a processor in a computer system or other system. In this sense, each may comprise, for example, statements including instructions and declarations that can be fetched from the computer-readable medium and executed by the instruction execution system. In the context of the present invention, a “computer-readable medium” can be any medium that can contain, store, or maintain the server/client side database replication systems 123/136 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A method for updating an application in at least one application server, comprising:
providing a number of applications stored in a first application database in an update server, wherein each of the applications comprises a number of application components; and
performing a database replication operation with at least one application server to replicate the applications stored in the first application database in a second application database in the application server, thereby installing the applications on the application server.

2. The method of claim 1, further comprising providing a number of registries in the first application database, each of the registries being associated with a respective one of the applications in the first application database.

3. The method of claim 1, further comprising listing the number of components associated with a respective one of the applications in the registry associated with the respective one of the applications.

4. The method of claim 1, further comprising initiating the performance of the database replication operation at a predetermined times.

5. The method of claim 1, further comprising initiating the performance of the database replication operation upon a receipt of a request to perform the database replication from the at least one application server.

6. The method of claim 1, further comprising initiating the performance of the database replication operation upon an occurrence of a change in the first application database in the update server.

7. The method of claim 6, further comprising changing the first application database by adding an application component thereto.

8. The method of claim 6, further comprising changing the first application database by altering a pre-existing one of the application components stored therein.

9. The method of claim 6, further comprising changing the first application database by replacing a pre-existing one of the application components stored therein with an updated version of the pre-existing one of the application components.

10. The method of claim 6, further comprising changing the first application database by removing one of the application components from the first application database.

11. An update server for updating an application in at least one application server, comprising:
a processor circuit having a processor and a memory;
an application database stored in the memory, the application database including a number of applications, each of the applications comprising a number of application components; and
a database replication system stored in the memory and executable by the processor, the database replication system being configured to interface with a second database replication system in at least one application server to perform a replication operation to replicate the application database in the at least one application server, thereby installing the number of applications in the at least one application server.

12. The update server of claim 11, further comprising logic that initiates the performance of the replication operation upon receiving a request to perform the replication operation from the at least one application server.

13. The update server of claim 11, further comprising logic that initiates the performance of the replication operation upon an occurrence of a change in the application database.

14. The update server of claim 11, further comprising a number of registries in the first application database, each of the registries being associated with a respective one of the applications in the first application database.

15. The update server of claim 14, wherein each of the registries lists the number of components associated with a respective one of the applications.

16. A system for updating an application in at least one application server, comprising:
an application database storing a number of applications, each of the applications comprising a number of application components; and
means for performing a replication operation to replicate the application database in at least one application server in conjunction with a second application database replication system in the at least one application server, thereby installing the applications on the application server.

17. The system of claim 16, further comprising means for initiating the replication operation upon receiving a request to perform the database replication from the at least one application server.

18. The system of claim 16, further comprising means for initiating the replication operation upon an occurrence of a change in the application database.

19. A method for executing an application, comprising:
providing a number of applications stored in an application database, wherein each of the applications includes a number of application components;
querying the application database for a number of the application components associated with a respective one of the applications; and
executing the respective one of the applications when all of the application components associated therewith have been retrieved from the application database.

20. The method of claim 19, further comprising querying the application database for a registry associated with the respective one of the applications, the registry listing the application components associated with the respective one of the applications.

21. The method of claim 20, wherein the querying of the application database for the number of the application components associated with the respective one of the applications further comprises identifying the number of application components associated with the respective one of the applications from the registry.

22. The method of claim 20, further comprising receiving a uniform resource indicator from a client that is associated with the registry.

23. The method of claim 22, wherein looking up the registry based upon the uniform resource indicator in a look-up table.

24. A program embodied in a computer readable medium for executing an application, comprising:
code that queries an application database for a number of application components associated with an application;
code that loads the application components obtained from the application database into a random access portion of a memory; and
code that executes the application.

25. The program embodied in a computer readable medium of claim 24, further comprising code that queries the application database for a registry associated with the application, the registry listing the application components associated with the application.

26. The program embodied in a computer readable medium of claim 25, wherein the code that queries the application database for the number of application components associated with the application further comprises code that identifies the application components from the registry.

27. A system for executing an application, comprising:
a processor circuit having a processor and a memory;
an application database stored in the memory, the application database including a number of applications, each of the applications comprising a number of application components;
logic stored in the memory and executable by the processor that queries the application database for specific ones of the application components associated with a respective one of the applications;
logic stored in the memory and executable by the processor that loads the application components associated with the respective one of the applications obtained from the application database into a random access portion of the memory; and
logic stored in the memory and executable by the processor that executes the respective one of the applications.

28. The system of claim 27, further comprising logic stored in the memory and executable by the processor that queries the application database for a registry associated with the respective one of the applications, the registry listing the application components associated with the respective one of the applications.

29. The system of claim 28, wherein the logic that queries the application database for specific ones of the application components associated with the respective one of the applications further comprises logic that identifies the number of application components associated with the respective one of the applications from the registry.

30. A system for executing an application, comprising:
means for querying an application database for a number of application components associated with an application;
means for loading the application components obtained from the application database into a random access portion of a memory; and
means for executing the application.
